(19) United States
(12) Patent Application Publication
(10) Pub. No.: US 2025/0311704 A1
(43) Pub. Date: Oct. 9, 2025

(54) Adjustable Dog Leash System

(71) Applicant: Louis Lotta, Sr., Ontario, NY (US)

(72) Inventor: Louis Lotta, Sr., Ontario, NY (US)

(21) Appl. No.: 18/625,352

(22) Filed: Apr. 3, 2024

(51) Int. Cl. A01K 27/00

(52) U.S. Cl. CPC A01K 27/003; A01K 27/006; A01K 27/008

(57) ABSTRACT

An adjustable dog leash system is designed to permit a user to walk two dogs simultaneously and includes a leash assembly, a handle, and an adjustment structure. The leash assembly includes a first strap, a first collar attachment connected to the first strap, a second strap, and a second collar attachment connected to the second strap. The adjustment structure includes a band that divides the first and second straps into a stacked section between the adjustment structure and the handle and an unstacked section between the adjustment structure and the collar attachments. The band is slidable toward the handle to increase the length of the unstacked section to permit the two dogs to move further away from each other, and away from the handle to decrease the length of the unstacked section to keep the two dogs closer together.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to dog leash systems and more particularly pertains to a new adjustable dog leash system for walking two dogs simultaneously that is adjustable to adjust the distance that the dogs can walk apart from one another.

### (2) Description of Related Art Including Information Disclosed Under 37 CFR 1.97 and 1.98

The prior art relates to dog leash systems. The prior art, as best understood, does not disclose adjustable dog leash system for walking two dogs simultaneously that is adjustable to adjust the distance that the dogs can walk apart from one another, wherein the user can adjust the length of the leashes so as to keep the dogs closer together or allow them to walk further apart.

### BRIEF SUMMARY OF THE INVENTION

An embodiment of the disclosure meets the needs presented above in an adjustable dog leash system designed to permit a user to walk two dogs simultaneously and generally comprising a leash assembly, a handle, and an adjustment structure. The leash assembly includes a first strap, a first collar attachment connected to the first strap, a second strap, and a second collar attachment connected to the second strap. The handle is connected to the leash assembly. The adjustment structure includes a band positioned about the first strap and the second strap and designed to divide the first and second straps into a stacked section between the adjustment structure and the handle and an unstacked section between the adjustment structure and the first and second collar attachments. The band is slidable toward the handle to decrease the length of the stacked section and increase the length of the unstacked section to permit two dogs connected to the leash assembly to move further away from each other, and is slidable away from the handle to decrease the length of the unstacked section and increase the length of the stacked section to keep two dogs connected to the leash assembly closer together.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of an adjustable dog leash system according to an embodiment of the disclosure.

FIG. 2 is a side view of an embodiment of the disclosure.

FIG. 3 is a front view of an embodiment of the disclosure.

FIG. 4 is a rear view of an embodiment of the disclosure.

FIG. 5 is a close-up perspective view of a portion of an embodiment of the disclosure.

FIG. 6 is a side perspective view of an embodiment of the disclosure in use.

### DETAILED DESCRIPTION OF THE INVENTION

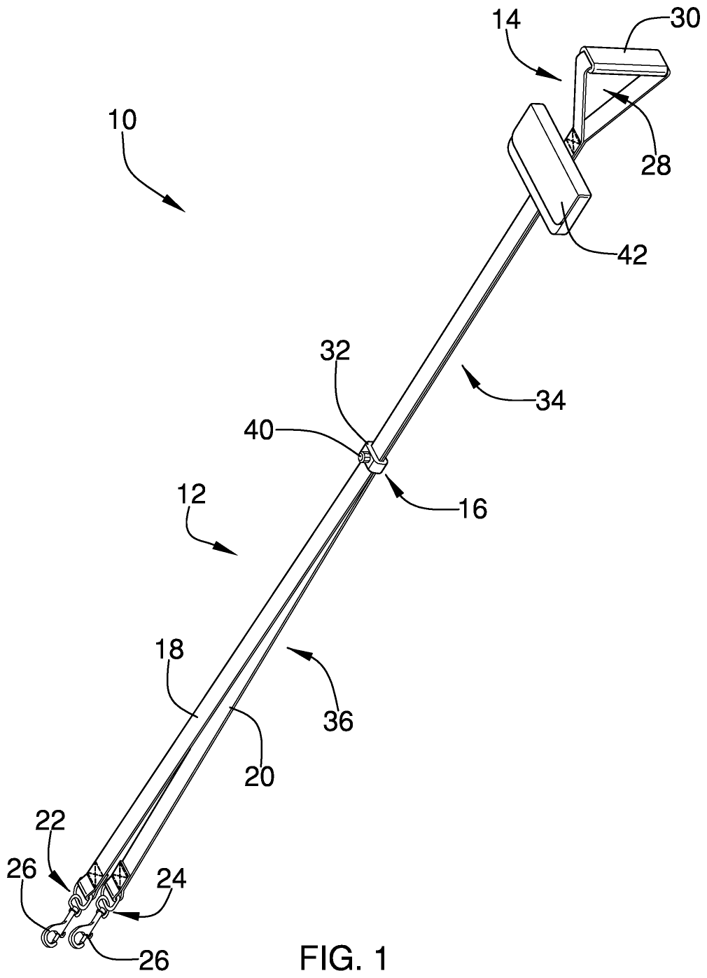

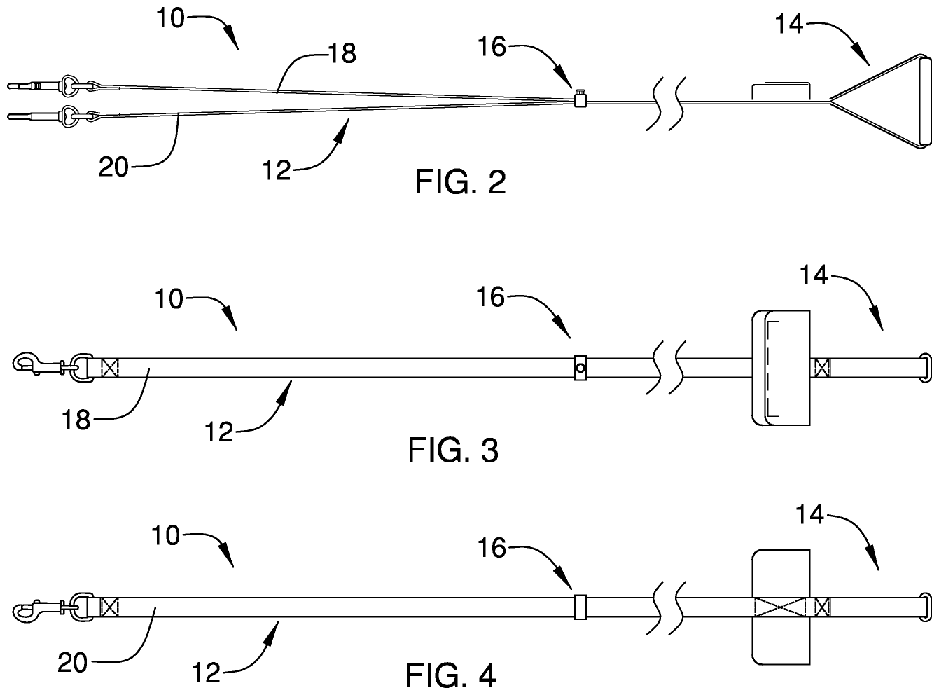

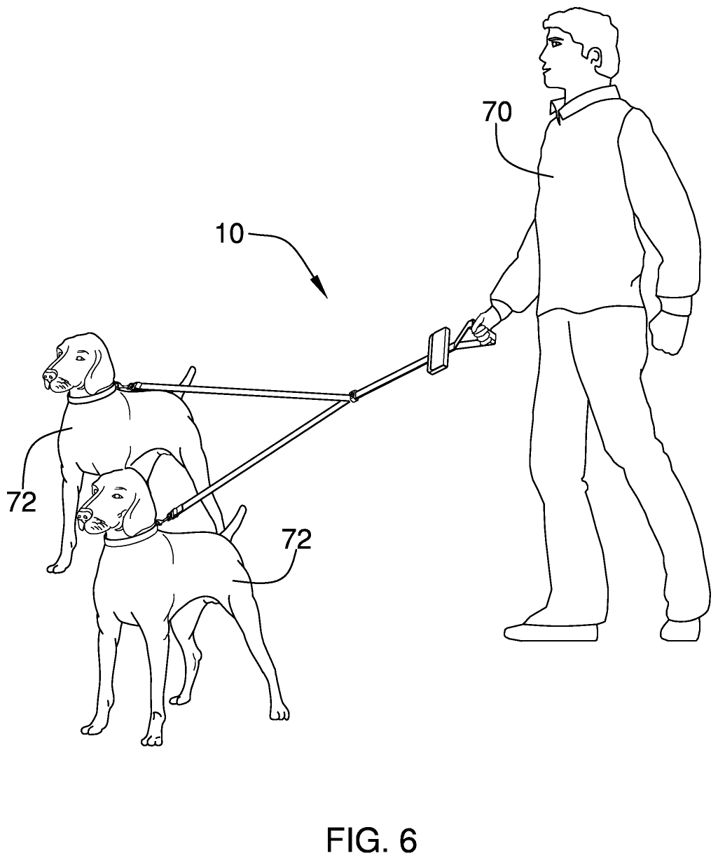

With reference now to the drawings, and in particular to FIGS. 1 through 6 thereof, a new adjustable dog leash system embodying the principles and concepts of an embodiment of the disclosure and generally designated by the reference numeral 10 will be described.

As best illustrated in FIGS. 1 through 6, the adjustable dog leash system 10 is designed to permit a user 70 to walk two dogs 72 simultaneously and includes a leash assembly 12, a handle 14, and an adjustment structure 16. The leash assembly 12 is designed to walk two dogs 72. The leash assembly 12 includes a first strap 18, a first collar attachment 22 connected to the first strap 18, a second strap 20, and a second collar attachment 24 connected to the second strap 20. Each of the first strap 18 and the second strap 20 includes a first end 26 and a second end 28. The first collar attachment 22 is connected to the first end 26 of the first strap 18. The second collar attachment 24 is connected to the first end 26 of the second strap 20. The second end 28 of the first strap 18 is attached to the second end 28 of the second strap 20 where the handle 14 begins. Each of the first and second collar attachments 22, 24 includes a leash clip 26 designed to be releasably connected to a dog collar 74.

The handle 14 is connected to the leash assembly 12 and includes a closed loop 28 that the user 70 can grasp. In the embodiment shown in the figures, the handle 14 includes a tube 30 positioned on and about the closed loop 28 and designed to be gripped by a hand of a user 70. The tube 30 could be made of plastic or metal or other suitable hard material to provide an ergonomic grip.

As shown in FIG. 1 the first strap 18, the second strap 20, and the closed loop 28 together are formed from a single strap folded in half, though it would be possible to form each part separately and attach them together, such as by stitching or adhesive. The closed loop 28 is formed by attaching, such as by stitching, the single strap to itself at a point adjacent a middle portion of the single strap. Regardless of whether the adjustable dog leash system 10 is made of a single strap or separate components attached together, this connection point also helps keep the first and second straps 18, 20 aligned when they are held in a stacked position by the adjustment structure 16, as will be discussed below.

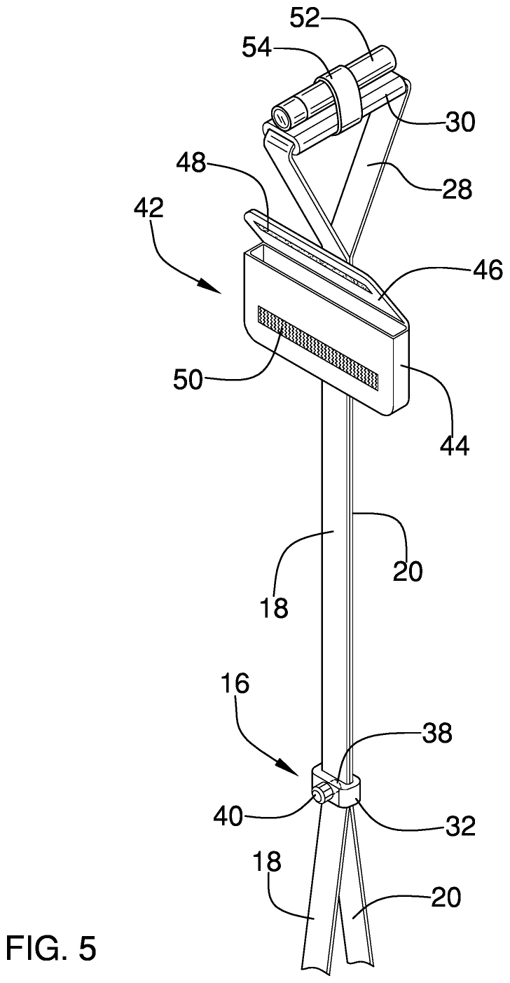

The adjustment structure 16 includes a band 32 positioned about the first strap 18 and the second strap 20. The band 32 is designed to divide the first and second straps 18, 20 into a stacked section 34 between the adjustment structure 16 and the handle 14 and an unstacked section 36 between the adjustment structure 16 and the first and second collar attachments 22, 24. The band 32 is slidable toward the handle 14 to decrease the length of the stacked section 34 and increase the length of the unstacked section 36 to permit two dogs 72 connected to the leash assembly 12 to move further away from each other. Conversely, the band 32 is slidable away from the handle 14 to decrease the length of the unstacked section 36 and increase the length of the stacked section 34 to keep two dogs 72 connected to the leash assembly 12 closer together. The adjustment structure 16 includes a securing device 38, shown in FIG. 5, which could be a set screw or post, designed to secure the adjustment band 32 in a desired position on the first and second straps 18, 20. In the embodiment shown in the figures, the securing device 38 includes a knob 40 that is rotatable to loosen or tighten the securing device 38.

As shown in the figures, the adjustable dog leash system 10 could also include a container 42 that is connected to one of the first and second straps 18, 20. The container 42 is designed to store small personal items, such as a cell phone, keys, wallet, or pepper spray, dog treats, and dog waste bags therein. The container 42 is positioned adjacent the handle 14 for easy access by the user 70, but could be positioned elsewhere. The container 42 includes a container body 44 and a foldable lid 46. The foldable lid 46 includes a first mating member 48 and the container body 44 includes a second mating member 50 to releasably secure the foldable lid 46 in a closed position on the container body 44. As shown in FIG. 5, the mating members 48, 50 could be hook-and-loop material strips, but could also be snaps, buttons, or other similar connecting structures. The container 42, as shown in FIG. 1, is a flexible pouch, but it could be a rigid or semi-rigid pouch or similar container. Also as shown in FIG. 1, the container 42 is elongated and attached transversely to one of the first and second straps 18, 20 by stitching. However, the container 42 could be attached parallel to the first and second straps 18, 20. The container 42 could also be detachably connected by hook-and-loop structures or snaps.

The adjustable dog leash system 10 could also include a flashlight 52 that is detachably connectable to the handle 14. The tube 30 includes a connecting structure 54, such as a strap as shown in FIG. 5 or a snap-fit bracket, to permit detachable connection of the flashlight 52 to the tube 30.

While the adjustable dog leash system 10 is shown in use with two dogs 72, it is possible for the adjustable dog leash system 10 to be adapted to be used with three or more dogs 72. For example, a third strap could be attached to the first and second straps 18, 20 in a stacked manner, and the band 32 could be adjusted in size to accommodate the additional strap. The band 32 would be slidably adjustable to perform the same function of increasing or decreasing the length of the unstacked section 36, such that the user 70 could give the dogs 72 greater space or keep them closer together.

To use the adjustable dog leash system 10, the user 70 detachably connects the first collar attachment 22 to a collar of a first dog and the second collar attachment 24 to a collar of a second dog. The user 70 can then slide the band 32 toward the handle 14 to increase the length of the unstacked section 36 to permit the dogs 72 to move further away from each other. Alternatively, the user 70 can then slide the band 32 away from the handle 14 to decrease the length of the unstacked section 36 to keep the dogs 72 closer together. If the adjustable dog leash system 10 includes the container 42, the user 70 can store items in the container 42 that would be useful during a walk, such as a cell phone, dog treats, or dog waste bags. If the adjustable dog leash system 10 includes the flashlight 52, the user 70 can use the flashlight 52 as needed to illuminate where he or she is walking.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. An adjustable dog leash system configured to permit a user to walk two dogs simultaneously comprising:
a leash assembly comprising a first strap, a first collar attachment connected to said first strap, a second strap, and a second collar attachment connected to said second strap;
a handle connected to said leash assembly;
an adjustment structure comprising a band disposed about said first strap and said second strap and configured to divide said first and second straps into a stacked section between said adjustment structure and said handle and an unstacked section between said adjustment structure and said first and second collar attachments; and
said band being slidable toward said handle to decrease the length of said stacked section and increase the length of said unstacked section to permit two dogs connected to said leash assembly to move further away from each other, and being slidable away from said handle to decrease the length of said unstacked section and increase the length of said stacked section to keep two dogs connected to said leash assembly closer together.

2. The adjustable dog leash system of claim 1, wherein:
each of said first strap and said second strap comprises a first end and a second end;
said first collar attachment is connected to said first end of said first strap;
said second collar attachment is connected to said first end of said second strap; and
said second end of said first strap is attached to said second end of said second strap.

3. The adjustable dog leash system of claim 1, wherein each of said first and second collar attachments comprises a leash clip configured to be releasably connected to a dog collar.

4. The adjustable dog leash system of claim 1, wherein said handle comprises a closed loop.

5. The adjustable dog leash system of claim 4, wherein said handle comprises a tube disposed on and about said closed loop and configured to be gripped by a hand of a user.

6. The adjustable dog leash system of claim 5, wherein said tube comprises plastic.

7. The adjustable dog leash system of claim 6, wherein said tube comprises a connecting structure to permit detachable connection of a flashlight to said tube.

8. The adjustable dog leash system of claim 1, wherein said adjustment structure comprises a securing device configured to secure said adjustment band in a desired position on said first and second straps.

9. The adjustable dog leash system of claim 8, wherein said securing device comprises a knob being rotatable to loosen or tighten said securing device.

10. The adjustable dog leash system of claim 1, wherein said adjustable dog leash system comprises a container connected to one of said first and second straps and configured to store small personal items, dog treats, and dog waste bags therein.

11. The adjustable dog leash system of claim 10, wherein said container is disposed adjacent said handle.

12. The adjustable dog leash system of claim 11, wherein said container comprises a container body and a foldable lid, and said foldable lid comprises a first mating member and said container body comprises a second mating member to releasably secure said foldable lid in a closed position on said container body.

13. The adjustable dog leash system of claim 12, wherein said container comprises a flexible pouch.

14. The adjustable dog leash system of claim 13, wherein said container is elongated and attached transversely to one of said first and second straps by stitching.

15. The adjustable dog leash system of claim 1, wherein said adjustable dog leash system comprises a flashlight being detachably connectable to said handle.

16. The adjustable dog leash system of claim 4, wherein:
said first strap, said second strap, and said closed loop together comprise a single strap folded in half; and
said closed loop is formed by attaching said single strap to itself at a point adjacent a middle portion of said single strap.

17. A method of using the adjustable dog leash system of claim 1 to walk two dogs simultaneously, comprising the steps of:
detachably connecting said first collar attachment to a collar of a first dog;
detachably connecting said second collar attachment to a collar of a second dog; and
sliding said band toward or away from said handle to either increase the length of said unstacked section to permit said first and second dogs to move further away from each other or decrease the length of said unstacked section to keep said first and second dogs closer together,

18. The method of claim 17, wherein said adjustable dog leash system comprises a container connected to one of said first and second straps and configured to store small personal items, dog treats, and dog waste bags therein, and said method further comprises carrying small personal items, dog treats, or dog waste bags in said container while walking said first and second dogs.

19. The method of claim 17, wherein said adjustable dog leash system comprises a flashlight being detachably connectable to said handle, and said method further comprises detaching said flashlight from said handle and using said flashlight to illuminate the surrounding area while walking said first and second dogs.

20. An adjustable dog leash system configured to permit a user to walk two dogs simultaneously comprising:
a leash assembly comprising a first strap, a first collar attachment connected to said first strap, a second strap, and a second collar attachment connected to said second strap; each of said first strap and said second strap comprises a first end and a second end; said first collar attachment is connected to said first end of said first strap; said second collar attachment is connected to said first end of said second strap; said second end of said first strap is attached to said second end of said second strap; each of said first and second collar attachments comprises a leash clip configured to be releasably connected to a dog collar;
a handle connected to said leash assembly; said handle comprises a closed loop; said handle comprises a tube disposed on and about said closed loop and configured to be gripped by a hand of a user; said tube comprises plastic; said tube comprises a connecting structure to permit detachable connection of a flashlight to said tube;
an adjustment structure comprising a band disposed about said first strap and said second strap and configured to divide said first and second straps into a stacked section between said adjustment structure and said handle and an unstacked section between said adjustment structure and said first and second collar attachments; said band being slidable toward said handle to decrease the length of said stacked section and increase the length of said unstacked section to permit two dogs connected to said leash assembly to move further away from each other, and being slidable away from said handle to decrease the length of said unstacked section and increase the length of said stacked section to keep two dogs connected to said leash assembly closer together; said adjustment structure comprises a securing device configured to secure said adjustment band in a desired position on said first and second straps; said adjustment structure comprises a threaded securing knob being rotatable to loosen or tighten said securing device;
a container is connected to one of said first and second straps and configured to store small personal items, dog treats, and dog waste bags therein; said container is disposed adjacent said handle; said container comprises a container body and a foldable lid; said foldable lid comprises a first mating member and said container body comprises a second mating member to releasably secure said foldable lid in a closed position on said container body; said container comprises a flexible pouch; said container is elongated and attached transversely to one of said first and second straps by stitching;
a flashlight being detachably connectable to said handle; and
said first strap, said second strap, and said loop together comprise a single strap folded in half; said loop is formed by stitching said single strap to itself at a point adjacent a middle portion of said single strap.
